(19) United States
(12) Patent Application Publication
(10) Pub. No.: US 2013/0307356 A1
(43) Pub. Date: Nov. 21, 2013

(54) DISK MOTOR AND ELECTRIC-POWERED WORKING MACHINE

(71) Applicant: Hideyuki Tanimoto, Hitachinaka (JP)

(72) Inventor: Hideyuki Tanimoto, Hitachinaka (JP)

(73) Assignee: HITACHI KOKI CO., LTD., Tokyo (JP)

(21) Appl. No.: 13/980,224

(22) PCT Filed: Jan. 31, 2012
(86) PCT No.: PCT/JP2012/000614

§ 371 Date: Jul. 17, 2013

(30) Foreign Application Priority Data
Jan. 31, 2011 (JP) 2011-017958

(51) Int. Cl. H02K 3/26; H02K 7/14

(52) U.S. Cl. CPC H02K 3/26; H02K 7/145
USPC 310/50; 310/208

(57) ABSTRACT

A disk motor includes a rotor, a stator, and an output shaft which is coaxially integrated with the rotor, a coil disk is provided in one of the rotor and the stator, a magnetic-flux generating part is provided in the other of the rotor and the stator, and the coil disk is configured by laminating a plurality of coil substrates each on which a coil pattern is printed. Among these coil substrates, in the coil substrates 40Aa and 40Af on both ends in the laminating direction having relatively good heat dissipation effect, the coils are electrically connected in series to each other, and, in the coil substrates 40Ab to 40Ae on an inner side in the laminating direction having relatively poor heat dissipation effect. at least a part of the coils is electrically connected in parallel to each other.

### TECHNICAL FIELD

The present invention relates to a disk motor including a rotor in which a plurality of coil substrates are laminated and an electric-powered working machine including a disk motor.

### BACKGROUND ART

Conventionally, as this type of the disk motor, there is a disk motor including: a rotor in which a plurality of coil-pattern printed coil substrates each having a substantially disk shape are laminated; a magnet for generating magnetic flux vertical to a rotational surface of the rotor; and a slider for supplying current to the rotor (see, for example, Patent Literature 1). In the disk motor as disclosed in Patent Literature 1, among the coil patterns printed on the rotor, a portion of a coil piece vertical to a rotor shaft of the rotor is widen, and besides, is branched off into two pieces by making a slit in its center, so that an electric resistance of the coil piece is reduced as suppressing the eddy current loss in the coil piece.

### CITATION LIST

### Patent Literature

PTL 1: Patent 2008-99429

### SUMMARY OF INVENTION

### Technical Problem

In such a disk motor, the coil substrate generates heat with the driving of the disk motor, and, when a temperature of the coil substrate is increased, a copper loss is increased, and therefore, power output of the disk motor is decreased. In order to suppress the increase in the temperature of the coil substrate, it is considered that the number of the laminated coil substrates is twice as many, and besides, the coil pieces in the every two coil substrates are electrically connected in parallel to each other, so that heat quantity generated per one coil substrate is decreased. However, this leads to increase in a thickness of the rotor so as to increase a size of the disk motor, and besides, to lengthen a magnetic flux path which passes through the rotor, and therefore, a powerful magnet is necessary.

The present invention has been made in consideration of the above-described circumstances, and a preferred aim of the invention is to provide the disk motor with suppressing the increase in the temperature of the coil substrate of the rotor as suppressing the thickness of the rotor, and provide an electric-powered working machine including the disk motor.

### Solution to Problem

In order to achieve the preferred aim, a disk motor according to a first viewpoint of the present invention is a disk motor including a rotor, a stator, and an output shaft which is coaxially integrated with the rotor, a coil disk is provided in one of the rotor and the stator, a magnetic-flux generating part is provided in the other of the rotor and the stator, the coil disk is configured by laminating a plurality of coil substrates each on which a coil is formed, and the coil disk includes: a first coil substrate part which is arranged on both-end sides in a laminating direction and which generates first heat quantity per one of the plurality of coil substrates and per unit time when a predetermined voltage is applied thereto; and a second coil substrate part which is arranged on an inner side in the laminating direction and which generates second heat quantity per one of the plurality of coil substrates and per unit time smaller than the first heat quantity when the predetermined voltage is applied thereto.

Also, in the second coil substrate part, at least a part of the plurality of coil substrates may be electrically connected in parallel to each other, and, in the first coil substrate part, the plurality of coil substrates may be electrically connected in series to a coil substrate in the second coil substrate part.

Further, the coil substrates in the first coil substrate part and the coil substrates in the second coil substrate part may be made of the same member.

Alternatively, an electrical resistance of the coil formed on each coil substrate in the second coil substrate part may be smaller than an electrical resistance of the coil formed on each coil substrate in the first coil substrate part.

In addition, the disk motor may include a power supply part for supplying electric power to the plurality of coil substrates, and the magnetic-flux generating part generates magnetic flux on the plurality of coil substrates in the laminating direction.

Also, a disk motor according to a second viewpoint of the present invention is a disk motor including a rotor, a stator, and an output shaft which is coaxially integrated with the rotor, a coil disk is provided in one of the rotor and the stator, a magnetic-flux generating part is provided in the other of the rotor and the stator, the coil disk is configured by laminating a plurality of coil substrates each on which a coil is formed, and the coil disk includes: a first coil substrate part which is arranged on both-end sides in the laminating direction and in which a first current flows through the coil when a predetermined voltage is applied thereto; and a second coil substrate part which is arranged an inner side in the laminating direction and in which a second current smaller than the first current flows through the coil when the predetermined voltage is applied thereto.

Also, the coil disk may be provided in the rotor, and the magnetic-flux generating part may be provided in the stator.

Further, an electric-powered working machine according to a third viewpoint of the present invention includes the disk motor according to the first or second viewpoint of the present invention.

### Advantageous Effects of Invention

According to the present invention, a disk motor with suppressing increase in a temperature of the coil substrate of the rotor as suppressing a thickness of the rotor and an electric-powered working machine including the disk motor can be provided.

### BRIEF DESCRIPTION OF DRAWINGS

FIG. 1 is an outline perspective view showing an example of an outline of an electric-powered working machine according to one embodiment of the present invention;

FIG. 2 is a configuration schematic view showing an example of a disk motor of the present invention;

FIG. 3 is a configuration schematic view showing an example of an output shaft and a rotor of the disk motor;

FIG. 4 is an explanatory view showing an example of one surface of a coil substrate;

FIG. 5 is an explanatory view showing an example of the other surface of the coil substrate;

FIG. 6 is an explanatory view showing one of two coils printed on the coil substrate;

FIG. 7 is a circuit diagram showing an example of electrical connection of the coil substrate;

FIG. 8 is an explanatory view showing an example of one surface of a coil substrate in a modification example; and

FIG. 9 is an explanatory view showing an example of the other surface of the coil substrate in the modification example.

### DESCRIPTION OF EMBODIMENTS

Hereinafter, an electric-powered working machine according to an embodiment of the present invention is explained with reference to drawings.

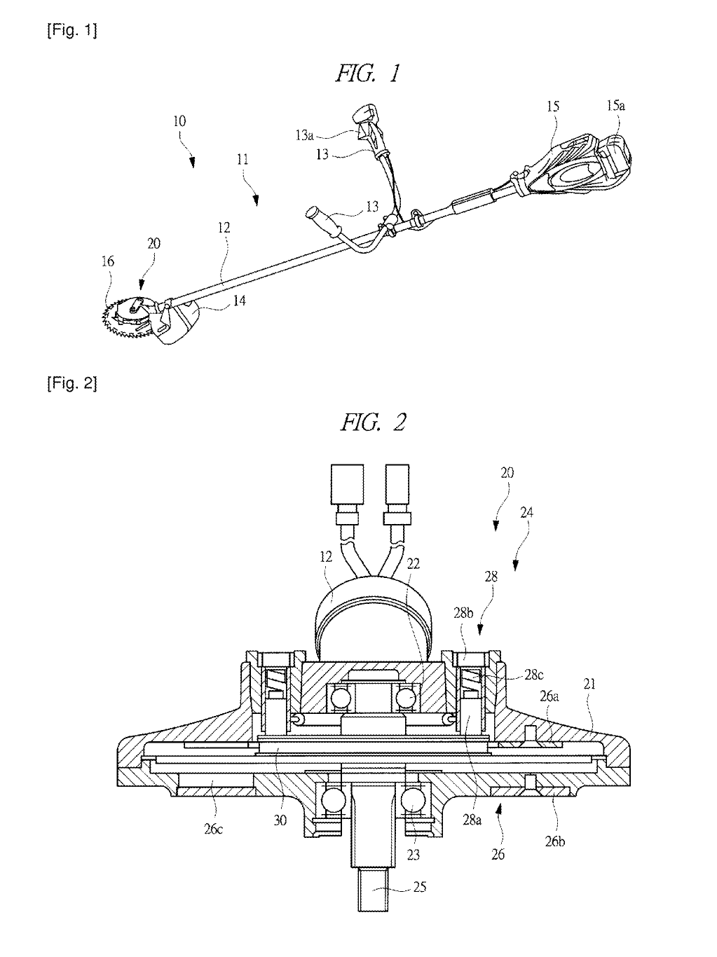

FIG. 1 is an outline view showing an example of an outline of an electric-powered working machine 10 according to an embodiment of the present invention. In the embodiment, the electric-powered working machine 10 is configured as an electric-powered mowing machine capable of performing a mowing work by rotating a cutting blade 16, and includes: a main pole part 11; a power source 15 for supplying electric power; and a driving part 20 for driving a working tool (cutting blade 16) as shown in the drawing.

The main pole part 11 includes: an operation pole 12 for connecting the driving part 20 to the power source 15; a handle 13 attached to the operation pole 12; and an antiscattering cover 14 for suppressing the scattering of foreign matters to an operator side during the working. The operation pole 12 is formed in a hollow bar shape made from a light and strong material such as aluminum alloy and reinforced plastic, and a power source line (not shown) for electrically connecting the driving part 20 to the power source 15 is inserted thereto. The handle 13 is attached to a portion slightly rearward from a center of the operation pole 12. In the handle 13, a trigger lever 13a is rotatably provided to the handle 13. The trigger lever 13a is operated by the operator, so that electric power is supplied from the power source 15 to the driving part 20 to activate the electric-powered working machine 10. Note that, in the embodiment, the handle 13 is formed in a U shape which extends so as to axially arc from the operation pole 12 as shown in the drawing. However, the handle may be formed in any shape such as a D shape and a T shape.

The power source 15 is attached to a rear end of the main pole part 11, and supplies electric power to the driving part 20. In the power source 15, a battery 15a is attached to a rear end of a power source casing. Here, the battery 15a may be any battery such as a secondary cell and a fuel cell, and may be chargeable through a power cord which is not shown, may be detached from the power source casing to be replaced, or may be chargeable by an external charging device.

FIG. 2 shows an example of a configuration of the driving part 20. The driving part 20 includes: a motor casing 21 attached to a front end of the operation pole 12; and a disk motor 24 which receives the electric power from the power source 15 and outputs motive power, and the cutting blade 16 (omitted in FIG. 2) is attached to an output shaft 25 of the disk motor 24. The motor casing 21 is attached to a front end of the operation pole 12 so that the operation pole 12 and an inside of the motor casing are communicated to each other, and a disk motor 24 is housed inside the motor casing.

The disk motor 24 is configured as a commutator motor which receives the electric power and outputs motive power to the output shaft 25, and includes: the output shaft 25; a rotor 30 integrally rotated with this output shaft 25; a stator 26 fixed to the motor casing 21; and a slider 28.

The output shaft 25 is rotatably supported by bearings 22 and 23 with respect to the motor casing 21, and one end of the output shaft is protruded from the motor casing 21, and the cutting blade 16 is attached thereto. As shown in FIG. 2, the stator 26 includes: a pair of upper yoke 26a and lower yoke 26b; and a magnet 26c which is a permanent magnet. The upper yoke 26a and the lower yoke 26b are formed in an annular plate shape made from a magnetic material such as iron, and are fixed to the motor casing 21, respectively. The upper yoke 26a is arranged so as to face an upper surface of the rotor 30, and the lower yoke 26b is arranged so as to face a lower surface of the rotor 30. The magnet 26c is formed in an annular shape which has a plurality of magnetic poles arranged in a circumference direction, and is fixed to an upper surface of the lower yoke 26b. With such a configuration, the stator 26 forms magnetic flux so that the magnetic flux generated by the magnet 26c passes through the rotor 30 in a shaft direction of the output shaft 25. The slider 28 is fixed to the motor casing 21 so as to be in slidable contact with an upper surface of the rotor 30 (more specifically, so as to be in slidable contact with a commutator disk 36 to be described later). In the slider 28, a brush 28a is arranged inside a brush holder 28b which is provided in the motor casing 21, and the brush 28a is energized onto the upper surface of the rotor 30 by a spring 28c. To the slider 28, the electric power from the power source 15 is supplied through a power source line (not shown) which is inserted into the operation pole 12.

FIG. 3 shows an example of an enlarged state of the output shaft 25 and the rotor 30 of the disk motor 24. In FIG. 3, outlines of the output shaft 25 and the rotor 30 are shown in its right half, and cross-sectional views of the output shaft 25 and the rotor 30 are shown in its left half. As shown in the drawing, the output shaft 25 includes a flange part 25a which can support the rotor 30, and the rotor 30 is attached to one end side of the flange part 25a so that the output shaft 25 and the rotor 30 integrally rotate.

The rotor 30 includes: a flange 32 fitted to the output shaft 25; the commutator disk 36 which is a commutator; a coil disk 40 formed by laminating six coil substrates 40A (40Aa to 40Af); and a plurality of insulating plates 34. The flange 32 is made of, for example, aluminum alloy or others, and includes; a hollow cylindrical shaft part 32a; and a disk-shaped flange part 32b which extends from the shaft part 32a. In the flange 32, an inner circumference surface of the shaft part 32a is fitted to an outer circumference surface of the output shaft 25 so as to be fixed to each other in a detent manner. In an outer circumference surface of the shaft part 32a, the commutator disk 36 is attached on one end side of the flange part 32b through the insulating plate 34, and the coil disk 40 is attached on the other end side of the flange part 32b through the insulating plate 34.

Each of the commutator disk 36 and the six coil substrates 40A (40Aa to 40Af) is formed by a printed-wiring board including an insulator substrate and a conductor pattern. On the commutator disk 36, a conductor pattern of the commutator is radially formed. On an upper surface and a lower surface of each of the coil substrates 40Aa to 40Af, a conductor pattern of a coil is radially formed. Note that, in the embodiment, the coil substrates Aa and Af on both ends in the laminating direction among the six coil substrates Aa to Af correspond to “the first coil substrate part”, and the inside coil substrates Ab to Ae correspond to “the second coil substrate part”.

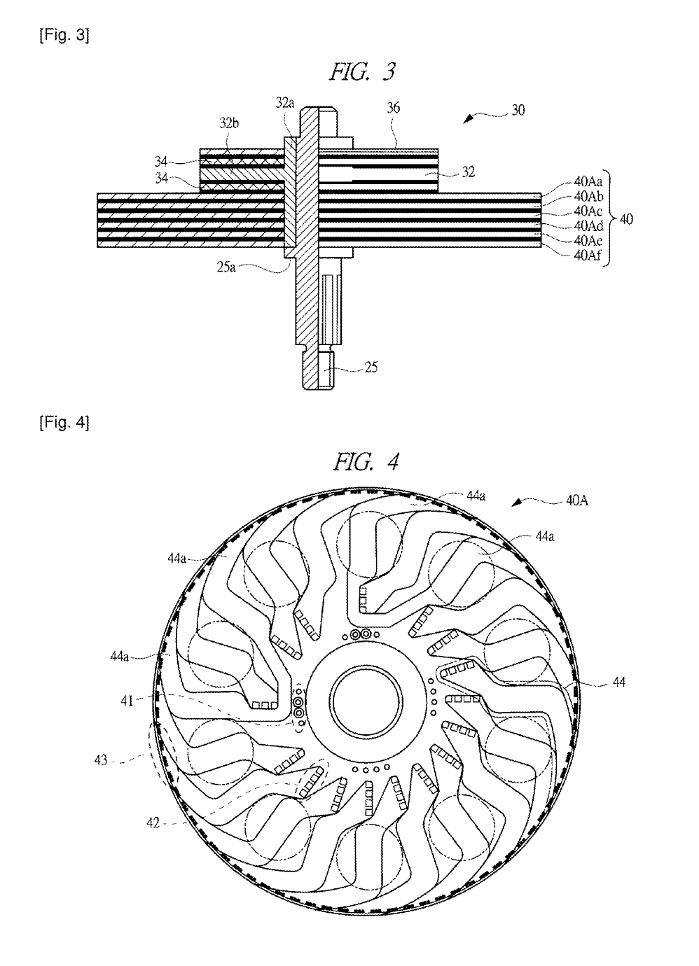

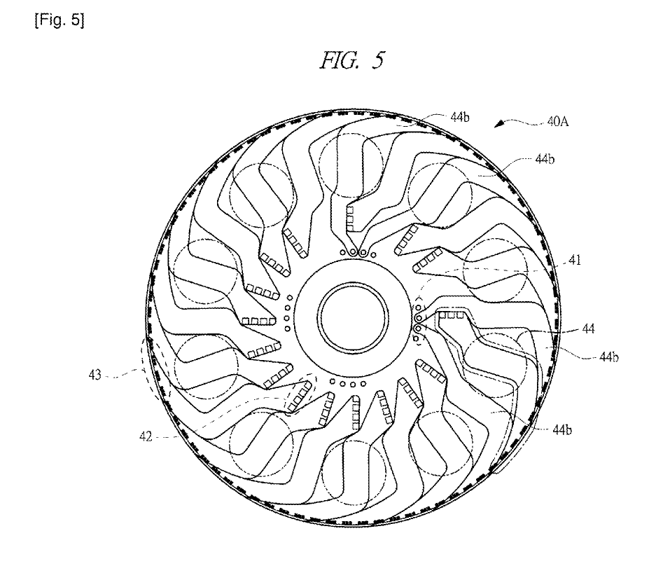

In the embodiment, for all of the six coil substrates 40A (40Aa to 40Af), a coil substrate 40A with the same (single) configuration is used. FIG. 4 shows an example of a state of the coil substrate 40A viewed from above of FIGS. 2 and 3, and FIG. 5 shows an example of a state of the coil substrate 40A viewed from below of FIGS. 2 and 3. Note that, in FIGS. 4 and 5, a position of the magnet 26c of the stator 26 is indicated by a two-dot chain line (its symbol is not shown). On an inner circumference side of the coil substrate 40A, a through-hole 41 which penetrates the coil substrate 40A in the shaft direction is provided, and this through-hole 41 is subjected to copper plating, and is electrically connected to the conductor pattern formed on the other coil substrate 40A or the commutator disk 36 by inserting and soldering a pin (not shown) thereto. Also, through-holes 42 and 43 are provided at positions corresponding to end portions on an inner circumference side and an outer circumference side of the conductor pattern printed on the coil substrate 40A, and these through-holes 42 and 43 are subjected to copper plating, so that the conductor pattern formed on the upper surface of the coil substrate 40A and the conductor pattern formed on the lower surface thereof are electrically connected to each other.

One of the radial coil patterns printed on the coil substrate 40A is defined as a partial coil 44 (for example, an area surrounded by a chain line in FIGS. 4 and 5). In the embodiment, as shown in FIGS. 4 and 5, 20 partial coils 44 are provided on each coil substrate 40A. The partial coil 44 includes a straight line part substantially vertical to the output shaft 25 (shaft center) at a position where the stator 26 is located, and is bent from the straight line part on the inner circumference side and the outer circumference side so as to be totally formed in a crank shape. Two of the partial coils 44 (partial coils 44a in FIG. 4) printed on the upper surface of the coil substrate 40A are connected to each other on the inner circumference side, and four of the partial coils 44 (partial coils 44b in FIG. 5) printed on the lower surface of the coil substrate 40A are connected to each through-hole 41. on the inner circumference side to be electrically connected to the other coil substrate 40A or the commutator disk 36. Such partial coils 44 are electrically connected thereto at the upper surface and the lower surface by the through-holes 42 and 43 on the inner circumference side and the outer circumference side of the coil substrate 40A to form two coils in the coil substrate 40A. FIG. 6 shows only one of two coils formed on the coil substrate 40A. FIG. 6 shows only one of the two coils formed in the coil substrate 40A. In FIG. 6, the coil. pattern of the one coil printed on the upper surface is shown by a solid line, and the coil pattern thereof printed on the lower surface is shown by a broken line. As shown in the drawing, the coil pattern printed on the upper surface and the coil pattern printed on the lower surface are overlapped at the positions of the through-holes 42 and 43, and are electrically connected to each other at these points. The coil formed in the coil substrate 40A goes back and forth between the upper surface side and the lower surface side with taking the through-holes 41 being a connecting point with the commutator disk as both ends, and turns back at a connecting point between the partial coils 44a on the upper surface, so that the coil is formed so as to go round twice in the circumference direction on the coil substrate 40A. Six of the coil substrates 40A as configured in this manner are laminated in the shaft direction (laminating direction) to configure the coil disk 40.

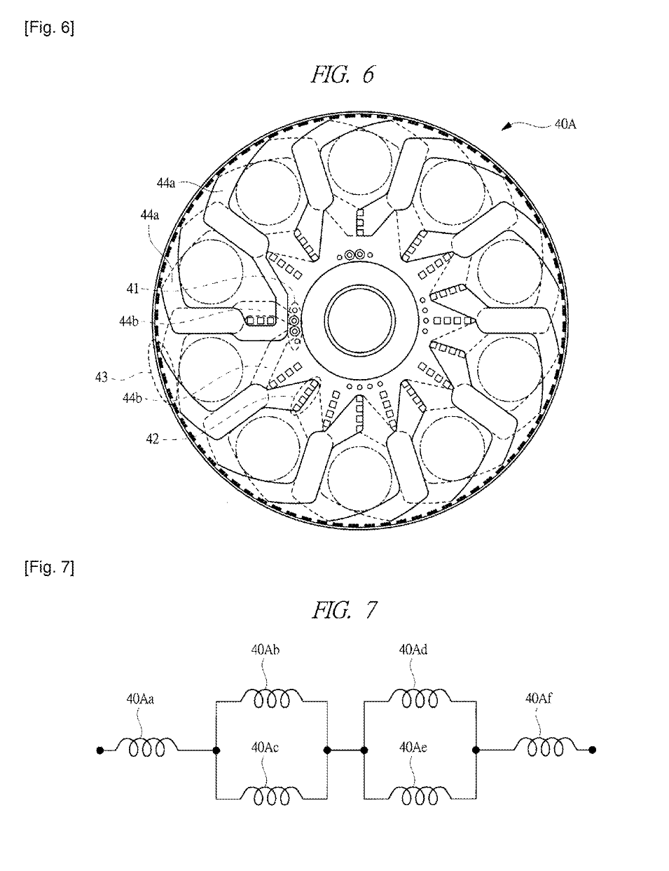

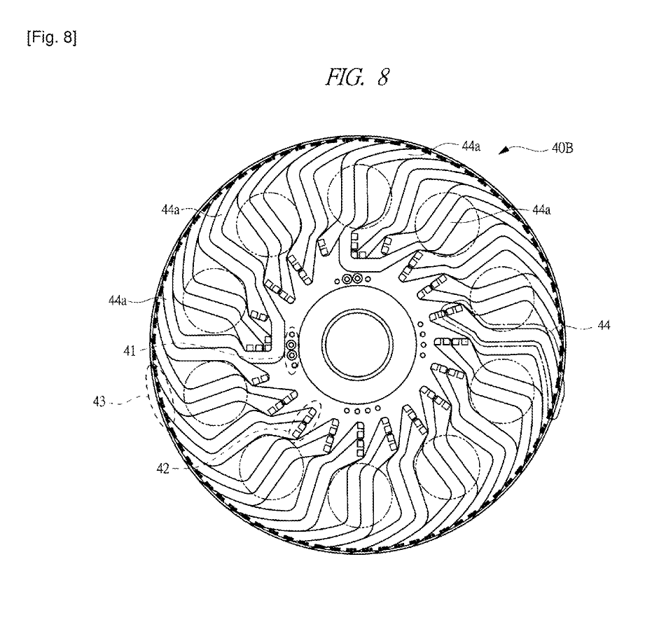

FIG. 7 shows an example of the electrical connection of the coils formed in six coil substrates 40A (40Aa to 400. Among the six coil substrates 40Aa to 40Af, the coils formed in the coil substrates 40Ab to 40Ae which are on the inner side in the laminating direction are electrically connected in parallel to each other for every two coil substrates 40A (in FIG. 7, 40Ab and 40Ac, and 40Ad and 40Ae are connected in parallel to each other). These parallely-connected coils and the coils formed in the coil substrates 40Aa and 40Af which are on the outer side (both ends) in the laminating direction are electrically connected in series to each other. That is, the coils formed in the coil substrates 40Aa and 40Af which are on both ends in the laminating direction are not electrically connected in parallel but in series to the coils formed in the other coil substrate 40A. And, one end of each coil formed in the coil substrates 40Aa and 40Af is connected to the commutator disk 32 (not shown) to supply the electric power from the power source 15 to the coil substrates 40Aa to 40Af. Here, in order to connect the coils formed in the two coil substrates 40A in parallel to each other, for example, the two coil substrates 40A may be laminated so that the two coil substrates 40A have the same phase, that is, the through-holes 41 are at the same position. Also, in order to connect the coils formed in the two coil substrates 40A in series to each other, for example, they may be laminated so that their phases are shifted such that one throughhole 41 of one of the coil substrates 40A is positioned at the other through-hole 41 of the other coil substrate 40A. By laminating the six coil substrates 40Aa to 40Af in this manner, when the electric power is supplied to the coils, the current flowing through the coil substrates 40Ab to 40Ae on the inner side is smaller than the current flowing through the coil substrates 40Aa and 40Af on the both ends in the laminating direction. Therefore, in the coil substrates 40Ab to 40Ae on the inner side, the generated heat quantity per substrate and per unit time is smaller than that in the coil substrates 40Aa and 40Af on the both ends. Each of the coil substrates 40Ab to 40Ae on the inner side has a smaller area contacting with the external air than those of the coil substrates 40Aa and 40Af on the both ends, and therefore, has poor heat dissipation effect. However, by reducing the heat quantity generated in the coil substrates 40Ab to 40Ae on the inner side in this manner, the increase in the temperature of the coil disk 40 can be suppressed. Also, by electrically connecting the coil substrates 40Aa and 40Af on the outer sides in series to each other, the power output of the disk motor 24 can be secured, and besides, the thickness of the coil disk 40 (rotor 30) can be suppressed. In addition, the magnetic flux path due to the stator 26 can be shortened, and besides, the entire disk motor 24 can be downsized. Further, the coil disk 40 is configured by laminating the plurality of the same coil substrates 40A, and therefore, the coil disk 40 can be manufactured easier than that obtained by laminating coil substrates each on which a plurality of coil patterns are printed.

In the electric-powered working machine 10 of the embodiment configured in this manner, the operator operates the trigger lever 13a with grabbing the handle 13 to apply the predetermined voltage from the power source 15 to the slider 28 of the disk motor 24, and this predetermined voltage is applied to the coil disk 40 of the rotor 30 through the commutator disk 36. The magnetic flux generated by the stator 26 passes through the rotor 30 in the shaft direction, and the current flowing through the coil disk 40 flows in a direction vertical to this magnetic flux and orthogonal to the central shaft of the output shaft 25, and therefore, a rotating force around the output shaft 25 is generated, so that the rotor 30 and the output shaft 25 as well as the cutting blade 16 attached to the output shaft 25 are integrally rotated. By rotating the cutting blade 16 in this manner, the operator can perform the mowing work.

In the electric-powered working machine 10 of the embodiment as described above, the coil disk 40 configuring the rotor 30 of the disk motor 24 is formed such that every two of the coil substrates 40Ab to 40Ae on the inner side in the laminating direction are electrically connected in parallel to each other, and besides, such that the coil substrates 40Aa and 40Af on the both ends in the laminating direction are electrically connected in series to each other, so that the heat quantity per substrate and per unit time generated in the coil substrates 40Ab to 40Ae on the inner side is smaller than the heat quantity per substrate and per unit time generated in the coil substrates 40Aa and 40Af on the both ends in the laminating direction. Therefore, the increase in the temperature of the coil substrates on the inner side having relatively poor heat dissipation effect can be suppressed, and thus, the decrease in the power output of the disk motor 24 due to the increase in the temperature of the coil disk 40 can be suppressed as securing a rated power output of the disk motor 24. Also, by electrically connecting the coil substrates 40Aa and 40Af on the both ends in the laminating direction having relatively good heat dissipation effect in series to each other, the increase in the thickness of the coil disk 40 can be suppressed as securing the rated power output of the disk motor 24, so that the magnetic flux path of the stator 26 can be shortened, and besides, the entire disk motor 24 can be downsized.

In the above-described coil disk 40, the six coil substrates are laminated. However, three to five coil substrates may be laminated, or seven or more coil substrates may be laminated.

In the above-described coil disk 40, every two of the coil substrates 40Ab to 40Ae on the inner side are electrically connected in parallel to each other, and then, the coil substrates are connected in series. However, as long as the current flowing through the coil substrates 40Ab to 40Ae on the inner side is smaller than the current flowing through the coil substrates 40Aa and 40Af on the both ends, the coil substrates may be connected in series first, and then, be connected in parallel. Also, three or more coil substrates 40A may be electrically connected in parallel. Further, for example, seven coil substrates 40Aa to 40Ag may be laminated, and every two of the coil substrates 40Aa, 40Ab, 40Af, and 40Ag on the outer side in the laminating direction may be electrically connected in parallel to each other, and three coil substrates 40Ac to 40Ae on the inner side may be electrically connected in parallel to each other. In this case, the coil substrates 40Aa, 40Ab, 40Af, and 40Ag correspond to “the first coil substrate part”, and the coil substrates 40Ac to 40Ae correspond to “the second coil substrate part”.

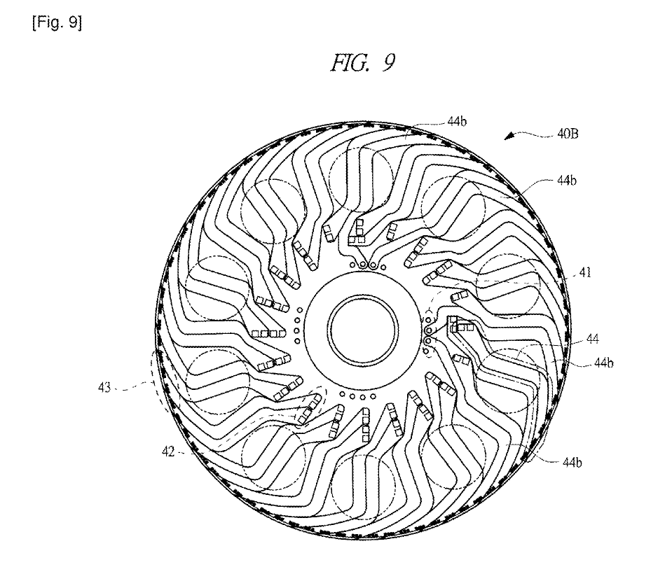

In the above-described coil disk 40, the plurality of coil substrates 40A each having the same coil pattern are laminated. However, the coil pattern on the coil disk 40 can be arbitrarily changed as long as the commutator motor is configured, and coil substrates each having a different pattern may be laminated. In this case, the coil patterns may be separated between the coil substrates on the both-end sides in the laminating direction and the coil substrates on the inner side so that the heat quantity per substrate and per unit time generated in the coil substrates on the inner side is smaller than the heat quantity per substrate and per unit time generated in the coil substrates on the both-end sides. FIG. 8 shows an example of an upper surface of a coil substrate 40B in a modification example, and FIG. 9 shows an example of a lower surface of the coil substrate 40B in the modification example. In the coil substrate 40B in the modification example, a width of the partial coil 44 is narrower than that of the coil substrate 40A in the embodiment so that the number thereof is twice as many as that. In this coil substrate 40B in the modification example, similarly to the coil substrate 40A in the embodiment, the partial coils 44 on the upper surface and the lower surface are connected to each other by the through-holes 42 and 43 to form two coils. Each of the coils of the coil substrate 40B in the modification example moves on the upper surface and the lower surface of the coil substrate 40B to go round thereon twice in a circumference direction, and turns back at a portion where the partial coils 44 are connected on the upper surface, and then, goes round thereon totally four times in the circumference direction. In the coil substrate 40B in the modification example, a coil path is longer than that of the coil substrate 40A in the embodiment, and besides, the electric resistance is larger since the coil width thereof is smaller. Even when the coil substrate 40B in the modification example is arranged on both ends in the laminating direction, when the coil substrate 40A in the embodiment is arranged on the inner side and is laminated, and when all of the coil substrates 40A and 40B are electrically connected in series to each other to configure the coil disk 40, the heat quantity generated per coil substrate 40A on the inner side and per unit time can be smaller than the heat quantity generated per coil substrate 40B on the both ends side and per unit time, and therefore, the increase in the temperature of the coil substrates can be suppressed as suppressing the increase in the thickness of the coil disk.

The stator 16 of the above-described embodiment includes the upper yoke 26a, the lower yoke 26b, and the magnet 26c. However, as long as the coil disk generates the magnetic flux passing through the output shaft of the motor in the shaft line direction, the stator may include, for example, a coil. Also, the arrangement of the magnetic pole may be arbitrarily changeable as long as the commutator motor can be configured.

In the above-described embodiment, the present invention has been described so as to be applied to the electric-powered mowing machine in which the cutting blade 16 is attached to the disk motor 24. However, the invention may be applied to any electric-powered working machine.

In the foregoing, the embodiment of the present invention has been described. However, it is needless to say that the present invention is not limited to the foregoing embodiment at all and various modifications can be made within the scope of the present invention.

### REFERENCE SIGNS LIST

10 electric-powered working machine
11 main pole part
12 operation pole
13 handle
13a trigger lever
14 antiscattering cover
15 power source
15a battery
16 cutting blade
20 driving part
21 motor casing
22 and 23 bearing
24 disk motor
25 output shaft
26 stator
26a upper yoke
26b lower yoke
26c magnet
28 slider
28a brush
28b brush holder
28c spring
30 rotor
32 flange
34 insulating plate
36 commutator disk
40 coil disk
40A, 40Aa to 40Af, and 40B coil substrate
41 to 43 through-hole
44 partial coil

1. A disk motor including: a rotor, a stator, and an output shaft which is coaxially integrated with the rotor, wherein:
a coil disk is provided in one of the rotor and the stator,
a magnetic-flux generating part is provided in the other of the rotor and the stator,
the coil disk is configured by laminating a plurality of coil substrates each on which a coil is formed, and
the coil disk includes:
a first coil substrate part which is arranged on both-end sides in a laminating direction and which generates first heat quantity per one of the plurality of coil substrates and per unit time when a predetermined voltage is applied thereto; and
a second coil substrate part which is arranged on an inner side in the laminating direction and which generates second heat quantity per one of the plurality of coil substrates and per unit time smaller than the first heat quantity when the predetermined voltage is applied thereto.

2. The disk motor according to claim 1, in the second coil substrate part, at least a part of the plurality of coil substrates is electrically connected in parallel to each other, and
in the first coil substrate part, each of the plurality of coil substrates is electrically connected in series to a coil substrate in the second coil substrate part.

3. The disk motor according to claim 1, wherein: the coil substrates in the first coil substrate part and the coil substrates in the second coil substrate part are made of the same member.

4. The disk motor according to claim 1, wherein:
an electrical resistance of the coil formed on each coil substrate in the second coil substrate part is smaller than an electrical resistance of the coil formed on each coil substrate in the first coil substrate part.

5. The disk motor according to claim 1, wherein:
the disk motor includes a power supply part for supplying electric power to the plurality of coil substrates, and
the magnetic-flux generating part generates magnetic flux on the plurality of coil substrates in the laminating direction.

6. A disk motor including a rotor, a stator, and an output shaft which is coaxially integrated with the rotor, wherein:
a coil disk is provided in one of the rotor and the stator,
a magnetic-flux generating part is provided in the other of the rotor and the stator,
the coil disk is configured by laminating a plurality of coil substrates each on which a coil is formed, and the coil disk includes:
a first coil substrate part which is arranged on both-end sides in a laminating direction and in which a first current flows through the coil when a predetermined voltage is applied thereto; and
a second coil substrate part which is arranged an inner side in the laminating direction and in which a second current smaller than the first current flows through the coil when the predetermined voltage is applied thereto.

7. The disk motor according to claim 1, wherein:
the coil disk is provided in the rotor, and
the magnetic-flux generating part is provided in the stator.

8. The disk motor according to claim 6, wherein:
the coil disk is provided in the rotor, and
the magnetic-flux generating part is provided in the stator.

9. An electric-powered working machine including the disk motor according to claim 1.

10. An electric-powered working machine including the disk motor according to claim 6.
